(19) United States
(12) Patent Application Publication
(10) Pub. No.: US 2026/0162895 A1
(43) Pub. Date: Jun. 11, 2026

(54) MULTILAYER ELECTRONIC COMPONENT

(71) Applicant: SAMSUNG ELECTRO-MECHANICS CO., LTD., Suwon-si (KR)

(72) Inventors: Hyung Soon KWON, Suwon-si (KR); Tae Young HAM, Suwon-si (KR); Hyoung Uk KIM, Suwon-si (KR); Yoon Soo PARK, Suwon-si (KR); Hye Won RYOO, Suwon-si (KR); Seok Hyun YOON, Suwon-si (KR)

(73) Assignee: SAMSUNG ELECTRO-MECHANICS CO., LTD., Suwon-si (KR)

(21) Appl. No.: 19/349,659

(22) Filed: Oct. 3, 2025

(30) Foreign Application Priority Data
Dec. 10, 2024 (KR) 10-2024-0182590

(51) Int. Cl. H01G 4/12; H01G 4/008; H01G 4/012; H01G 4/224; H01G 4/30

(52) U.S. Cl. CPC H01G 4/1209; H01G 4/008; H01G 4/012; H01G 4/224; H01G 4/30

(57) ABSTRACT

A multilayer electronic component according to an embodiment of the present disclosure may include a body including a capacitance formation portion including a dielectric layer and internal electrodes, the body having first and second surfaces opposing each other, third and fourth surfaces opposing each other, and fifth and sixth surfaces opposing each other, an external electrode disposed on the third and fourth surfaces, and a side margin portion disposed on the fifth and sixth surfaces. 0.2 mol≤S1−A1≤0.8 mol and S2−A2<0.25 mol are satisfied, where the number of mol of Mn and Mg for 100 mol of Ti included in the side margin portion are S1 and S2, respectively, and the number of mol of Mn and Mg for 100 mol of Ti included in the dielectric layer of the capacitance formation portion are A1 and A2, respectively.

### CROSS-REFERENCE TO RELATED APPLICATION(S)

This application claims benefit of priority to Korean Patent Application No. 10-2024-0182590 filed on Dec. 10, 2024 in the Korean Intellectual Property Office, the disclosure of which is incorporated herein by reference in its entirety.

### TECHNICAL FIELD

The present disclosure relates to a multilayer electronic component.

A multilayer ceramic capacitor (MLCC), a multilayer electronic component, is a chip-type condenser, mounted on the printed circuit boards of various types of electronic product, such as image display devices, including a liquid crystal display LCD and a plasma display panel PDP, computers, smartphones and mobile phones, and serves to charge or discharge electricity therein or therefrom. An MLCC may be used as a component in various electronic devices due to having a small size, ensuring high capacitance and being easily mounted.

In order to miniaturize and increase the capacitance of an MLCC, maximizing the effective area of the internal electrode is required. To maximize the width direction area of the internal electrode, a method has been applied in which a sheet forming the side margin portion is separately attached to a surface of a multilayer chip in the width direction before sintering and then sintering the chip.

Sintering behavior of the side margin portions, a microstructure of the side margin, and the like, are factors greatly affecting the reliability of an MLCC. Therefore, research into an optimal design of components configuring a sheet for forming the side margin portions is required.

### RELATED ART DOCUMENT

### Patent Document

(Patent document 1) Korean Patent No. 10-2015-0135092

### SUMMARY

An aspect of the present disclosure is to provide a highly reliable multilayer electronic component.

However, problems to be solved by the present disclosure are not limited to the above, and will be more easily understood in the process of describing specific embodiments of the present disclosure.

A multilayer electronic component according to an embodiment of the present disclosure may comprise: a body including a capacitance formation portion including a dielectric layer and internal electrodes alternately disposed with the dielectric layer in a first direction, first and second surfaces opposing each other in the first direction, third and fourth surfaces connected to the first and second surfaces and opposing each other in a second direction, and fifth and sixth surfaces connected to the first to fourth surfaces and opposing each other in a third direction, an external electrode disposed on the third and fourth surfaces, and a side margin portion disposed on the fifth and sixth surfaces, wherein 0.2 mol≤S1−A1≤0.8 mol and S2−A2<0.25 mol are satisfied, where an amount in mol of Mn and Mg for 100 mol of Ti included in the side margin portion are S1 and S2, respectively, and an amount in mol of Mn and Mg for 100 mol of Ti included in the dielectric layer of the capacitance formation portion are A1 and A2, respectively,

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a perspective view schematically illustrating a multilayer electronic component according to an embodiment of the present disclosure.

FIG. 2 is a perspective view schematically illustrating a body and a side margin portions of the embodiment illustrated in FIG. 1.

FIG. 3 is a perspective view schematically illustrating a body of the embodiment illustrated in FIG. 1.

FIG. 4 schematically illustrates a cross-sectional view taken along line I-I′ of FIG. 1.

FIG. 5 schematically illustrates a cross-sectional view taken along line II-II′ of FIG. 1.

FIG. 6 schematically illustrates a cross-sectional view similar to FIG. 5 but excluding internal electrodes, and a method for measuring a hardness of the side margin portion.

### DETAILED DESCRIPTION

Hereinafter, embodiments of the present disclosure will be described with reference to specific embodiments and the accompanying drawings. However, embodiments of the present disclosure may be modified into various other forms, and the scope of the present disclosure is not limited to the embodiments described below. Further, embodiments of the present disclosure may be provided for a more complete description of the present disclosure to the ordinary artisan. Therefore, shapes and sizes of the elements in the drawings may be exaggerated for clarity of description, and the elements denoted by the same reference numerals in the drawings may be the same elements.

In the drawings, portions not related to the description will be omitted for clarification of the present disclosure, and a thickness may be enlarged to clearly illustrate layers and regions. The same reference numerals will be used to designate the same components in the same reference numerals. Further, throughout the specification, when an element is referred to as “comprising” or “including” an element, it means that the element may further include other elements as well, without departing from the other elements, unless specifically stated otherwise.

In the drawings, a first direction X may be defined as a thickness direction T, a second direction Y may be defined as a length direction L, and a third direction Z may be defined as a width direction W.

### Multilayer Electronic Component

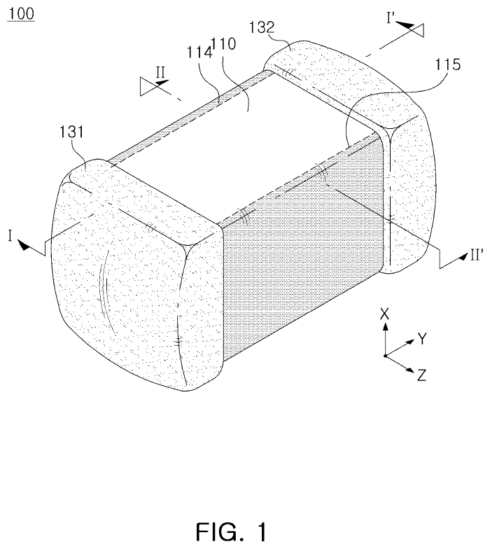

FIG. 1 is a perspective view schematically illustrating a multilayer electronic component according to an embodiment of the present disclosure.

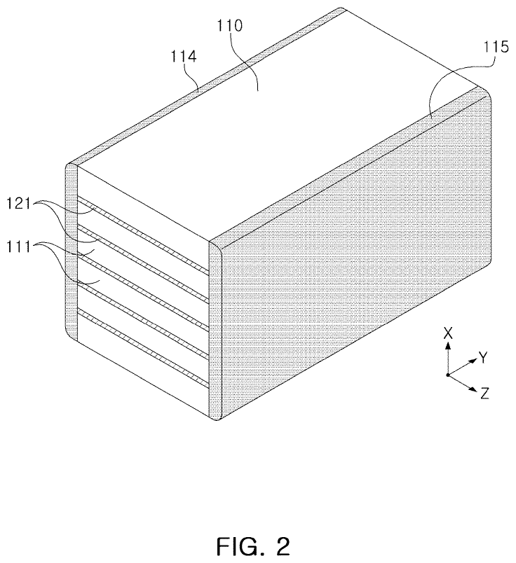

FIG. 2 is a perspective view schematically illustrating a body and a side margin portions of the embodiment illustrated in FIG. 1.

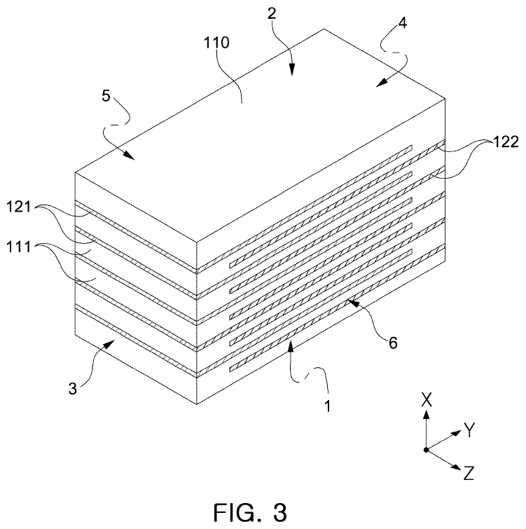

FIG. 3 is a perspective view schematically illustrating a body of the embodiment illustrated in FIG. 1.

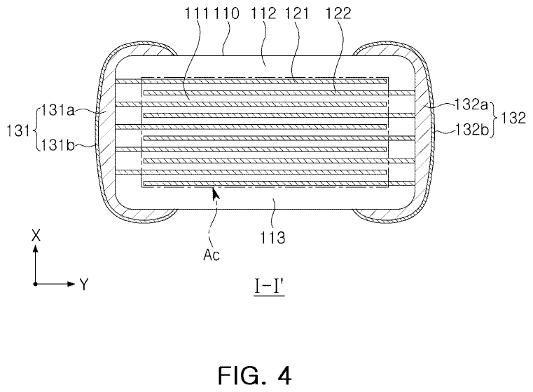

FIG. 4 schematically illustrates a cross-sectional view taken along line I-I′ of FIG. 1.

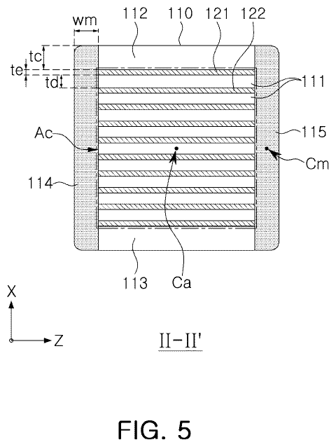

FIG. 5 schematically illustrates a cross-sectional view taken along line II-II′ of FIG. 1.

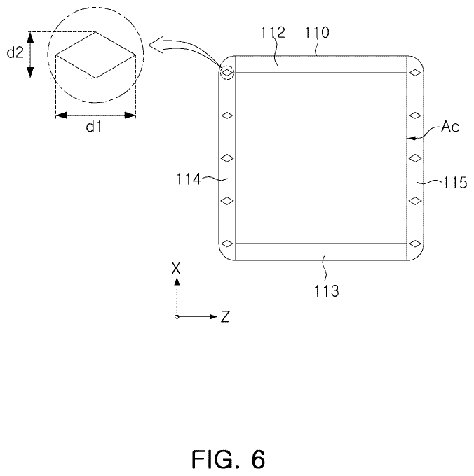

FIG. 6 schematically illustrates a cross-sectional view similar to FIG. 5 but excluding internal electrodes, and a method for measuring a hardness of the side margin portion.

Hereinafter, a multilayer electronic component 100 according to an embodiment of the present disclosure will be described in detail with reference to FIGS. 1 to 6. In addition, as an example of a multilayer electronic component, a multilayer ceramic capacitor is described, but the present disclosure is not limited thereto and may also be applied to various multilayer electronic components, such as inductors, piezoelectric elements, varistors, or thermistors.

A multilayer electronic component 100 according to an embodiment of the present disclosure may include a body 110, external electrodes 131 and 132, and the side margin portions 114 and 115.

There is no particular limitation on the specific shape of the body 110, but as illustrated, the body 110 may have a hexahedral shape or a shape similar thereto. Due to shrinkage of ceramic powder particles included in the body 110 during a sintering process or due to the polishing process for the corner portions of the body 110, the body 110 may not have a hexahedral shape with entirely straight lines, but may have a substantially hexahedral shape.

The body 110 may have first and second surfaces 1 and 2 opposing each other in the first direction, third and fourth surfaces 3 and 4 connected to the first and second surfaces 1 and 2 and opposing each other in the second direction, and fifth and sixth surfaces 5 and 6 connected to the first to fourth surfaces 1, 2, 3, and 4 and opposing each other in the third direction.

The body 110 may include a capacitance formation portion Ac disposed inside the body 110, and including a dielectric layer 111 and internal electrodes 121 and 122 disposed alternately with the dielectric layer 111 in the first direction to form capacitance. A plurality of dielectric layers 111 is in a sintered state, such that boundaries between adjacent dielectric layers 111 may be integrated so as to be difficult to identify without using a scanning electron microscope (SEM).

The dielectric layer 111 may include, for example, a perovskite-type compound represented by ABO₃ as a main component. The perovskite-type compound represented by ABO₃ may include, for example, one or more of BaTiO₃, (Ba₁₋ₓCaₓ)TiO₃ (0<x<1), Ba(Ti_{1-y}Ca_{y})O₃ (0<y<1), (Ba₁₋ₓCaₓ) (Ti_{1-y}Zr_{y})O₃ (0<x<1, 0<y<1), Ba(Ti_{1-y}Zr_{y})O₃ (0<x<1), CaZrO₃ and (Ca₁₋ₓSrₓ) (Zr_{1-y}Ti_{y})O₃ (0<x≤0.5, 0<y≤0.5).

The internal electrodes 121 and 122, for example, may include a first internal electrode 121 and a second internal electrode 122 that are alternately disposed in the first direction with the dielectric layer 111 interposed therebetween. The first and second internal electrodes 121 and 122 may be electrically separated from each other by the dielectric layer 111 disposed therebetween.

The first internal electrode 121 may be exposed to the third, fifth, and sixth surfaces 3, 5, and 6 but may be spaced apart from the fourth surface 4. The first internal electrode 121 may be connected to a first external electrode 131 on the third surface 3. The second internal electrode 122 may be exposed to the fourth, fifth, and sixth surfaces 4, 5 and 6 but may be spaced apart from the third surface 3. The second internal electrode 122 may be connected to a second external electrode 132 on the fourth surface 4.

Conductive metal included in the internal electrode 121 and 122 may be one or more of Ni, Cu, Pd, Ag, Au, Pt, Sn, W, Ti, and alloys thereof, and more preferably, may include Ni, but the present disclosure is not limited thereto.

The body 110 may include cover portions 112 and 113 respectively disposed on both surfaces of the capacitance formation portion Ac opposing in the first direction.

The side margin portions 114 and 115 may be disposed on the fifth and sixth surfaces 5 and 6 of the body 110, respectively. The multilayer electronic component 100 may include a first side margin portion 114 disposed on the fifth surface 5 and a second side margin portion 115 disposed on the sixth surface 6.

The cover portions 112 and 113 and the side margin portions 114 and 115 may include, for example, a perovskite-type compound represented by ABO₃ as a main component. The perovskite-type compound represented by ABO₃ may include, for example, one or more of BaTiO₃, (Ba₁₋ₓCaₓ) TiO₃ (0<x<1), Ba(Ti_{1-y}Ca_{y})O₃ (0<y<1), (Ba₁₋ₓCaₓ) (Ti_{1-y}Zr_{y})O₃ (0<x<1, 0<y<1), Ba(Ti_{1-y}Zr_{y})O₃ (0<x<1), CaZrO₃ and (Ca₁₋ₓSrₓ) (Zr_{1-y}Ti_{y})O₃ (0<x≤0.5, 0<y≤0.5).

External electrodes 131, 132 may be disposed on the third and fourth surfaces 3 and 4 of the body 110, respectively. The multilayer electronic component 100 may include the first external electrode 131 disposed on the third surface 3 and the second external electrode 132 disposed on the fourth surface 4. The first external electrode 131 may be disposed on the third surface 3 and may extend onto portions of the first, second, fifth and sixth surfaces 1, 2, 5, and 6, and the second external electrode 132 may be disposed on the fourth surface 4 and may extend onto portions of the first, second, fifth and sixth surfaces 1, 2, 5, and 6.

Types or shapes of the external electrodes 131 and 132 may not be particularly limited, and may have a multilayer structure. For example, the external electrodes 131 and 132 may include base electrode layers 131a and 132a in contact with the internal electrodes 121 and 122 and plating layers 131b and 132b disposed on the base electrode layers 131a and 132a.

The base electrode layers 131a and 132a may be sintered electrode layers including metal and glass. The metal included in the base electrode layers 131a and 132a may include, for example, Cu, Ni, Pd, Pt, Au, Ag, Pb, and/or alloys thereof. The glass included in the base electrode layers 131a and 132a may include, for example, one or more oxides of Ba, Ca, Zn, Al, B, and Si.

The base electrode layers 131a and 132a may be configured by only the sintered electrode layer, but the present disclosure may not be limited thereto and the base electrode layers 131a and 132a may include a sintered electrode layer including metal and glass, and a resin electrode layer disposed on the sintered electrode layer and including metal particles and resin.

The metal particles included in the resin electrode layer may include one or more of spherical particles and flake-shaped particles. In this case, the spherical particles may also include shapes that are not perfectly spherical, for example, shapes having a length ratio of a major axis to a minor axis (major axis/minor axis) of 1.45 or less. The flake-shaped particles refer to particles having a flat and elongated shape, and for example, the length ratio of the major axis to the minor axis (major axis/minor axis) may be 1.95 or greater. The metal particles included in the resin electrode layer may include, for example, Cu, Ni, Pd, Pt, Au, Ag, Pb, Sn and/or alloys thereof. The resin included in the resin electrode layer may include, for example, one or more of epoxy resin, acrylic resin, and ethyl cellulose.

The plated layers 131b and 132b may include, for example, Ni, Sn, Pd and/or alloys thereof, and may be formed of a plurality of layers. The plating layers 131b and 132b may be, for example, Ni plating layer or Sn plating layer, and may also be in the form in which the Ni plating layer and the Sn plating layer are formed sequentially thereon. The plating layers 131b and 132b may include a plurality of Ni plating layers and/or a plurality of Sn plating layers.

Although the drawing describes a structure in which a multilayer electronic component 100 has two external electrodes 131 and 132, it may not be limited thereto, and the number or shape of the external electrodes 131 and 132 may be changed depending on the shape of the internal electrodes 121 and 122 or other purposes.

When the same dielectric composition of the dielectric layer 111 of the capacitance formation portion Ac is applied to the side margin portions 114 and 115, it may be difficult to secure sinterability of the side margin portions 114 and 115. This is because the internal electrodes 121 and 122 including a conductive metal having a lower sintering initiation temperature than dielectric material, are disposed in the capacitance formation portion Ac.

Accordingly, when the same dielectric composition of the dielectric layer 111 is applied to the side margin portion 114 and 115, density of the side margin portions 114 and 115 may be reduced, and as a result, a reliability of the multilayer electronic component 100 may be deteriorated due to external moisture penetration through the side margin portions 114 and 115.

Previously, a certain amount of Mg was added to the side margin portions 114 and 115 to improve the density of the side margin portions 114 and 115. However, since Mg causes a creation of oxygen vacancy defects in the ABO₃ perovskite compound, a side effect of deteriorating the reliability of the multilayer electronic component 100 may be accompanied.

Mn, similar to Mg, may improve the density of the side margin portions 114 and 115 by lowering a densification initiation temperature of the side margin portions 114 and 115. Particularly, since Mn has multi-valence characteristics, the side effects due to oxygen vacancy defects may be less than those of Mg.

Accordingly, the multilayer electronic component 100 according to an embodiment of the present disclosure may satisfy 0.2 mol≤S1−A1≤0.8 mol, where the number of mol of Mn to 100 mol of Ti included in the side margin portions 114 and 115 is S1 and the number of mol of Mn to 100 mol of Ti included in the dielectric layer 111 of the capacitance formation portion Ac is A1. By ensuring S1−A1 (hereinafter referred to as ΔMn) satisfies the above range, the density of the side margin portions 114 and 115 may be secured, thereby effectively improving the reliability of the multilayer electronic component 100.

When ΔMn is less than 0.2 mol, an effect of improving the density of the side margin portions 114 and 115 may be minimal. When ΔMn exceeds 0.8 mol, a grain growth of dielectric grains included in the side margin portions 114 and 115 may be promoted, and excessive Mn may diffuse into the dielectric layer 111, which may have a negative effect of deteriorating a capacitance aging rate of the multilayer electronic component 100.

Meanwhile, when the multilayer electronic component 100 satisfies 0.2 mol≤ΔMn≤0.8, a content of Mg included in the side margin portions 114 and 115 may also need to be appropriately adjusted. When the content of Mg included in the side margin portions 114 and 115 increases excessively compared to the dielectric layer 111, it may cause excessive grain growth of the dielectric grains included in the side margin portions 114 and 115, thereby reducing the density of the side margin portions 114 and 115. This may cause a moisture resistance reliability of the multilayer electronic component 100 to deteriorate.

Accordingly, the multilayer electronic component 100 according to an embodiment of the present disclosure may satisfy S2−A2<0.25 mol, where the amount in mol of Mg to 100 mol of Ti included in the side margin portions 114 and 115 is S2, and the amount in mol of Mg to 100 mol of Ti included in the dielectric layer 111 of the capacitance formation portion Ac is A2. When 0.2 mol≤ΔMn≤0.8 mol is satisfied and S2−A2 (hereinafter referred to as ΔMg) exceeds 0.25 mol, there is a concern that the density of the side margin portions 114 and 115 may reduce, thereby reducing the reliability of the multilayer electronic component 100. A lower limit of ΔMg is not specifically limited and may be greater than or equal to 0.

The S1 is not particularly limited, but in an embodiment, may satisfy 0.1 mol≤S1≤1.1 mol. That is, a content of Mn included in the side margin portions 114 and 115 may be 0.1 mol or more and 1.1 mol or less based on 100 mol of Ti. When 0.1 mol≤S1≤1.1 mol is satisfied, a reliability improvement effect of the present disclosure may be more remarkable.

The S2 is not particularly limited, but may satisfy, for example, 0.45 mol≤S2≤1.25 mol. That is, the content of Mg included in the side margin portions 114 and 115 may be 0.45 mol or more and 1.25 mol or less based on 100 mol of Ti. When 0.45 mol≤S2≤1.25 mol is satisfied, the reliability improvement effect of the present disclosure may be more remarkable.

The S1 and S2 may be measured, for example, at a central portion Cm of the side margin portion in the first and third directions. The A1 and A2 may be measured, for example, at a central portion Ca of the capacitance formation portion in the first and third directions.

The S1, S2, A1, and A2 may be measured from an image observed by using, for example, a Scanning Electron Microscope-Energy Dispersive X-ray Spectrometer (SEM-EDS), a Transmission Electron Microscope-Energy Dispersive X-ray Spectrometer (TEM-EDS), a Scanning Transmission Electron Microscope-Energy Dispersive X-ray Spectrometer (STEM-EDS), or a Field Emission-scanning Electron Microscope-Energy Dispersive X-ray Spectrometer (FE-SEM-EDS). Other methods and/or tools appreciated by one of ordinary skill in the art, even if not described in the present disclosure, may also be used.

More specifically, as illustrated in FIG. 5, the multilayer electronic component 100 may be polished up to ½ point in the second direction to expose a cross-section of the multilayer electronic component 100 in the first and third directions. Thereafter, the contents (mol %) of Ti, Mn, and Mg in the central portion Cm of the side margin portions in the first and third direction are measured by using FE-SEM-EDS (acceleration voltage: 2 kV, magnification: 50,000 times). Accordingly, the amount in mol of S1 and S2 of Mn and Mg to 100 mol of Ti included in the side margin portions 114 and 115 may be calculated. Meanwhile, the amount in mol of Mn and Mg to 100 mol of Ti may be calculated at a plurality of points, for example, five equally spaced points, in the central portion Cm of the side margin portions in the first and third directions, and then the S1 and S2 may be measured by averaging each of the measured values. In this case, the central portion Cm of the side margin portions in the first and third directions may mean, for example, a region having a size of 5 μm×4 μm (third direction×first direction) based on the center of the side margin portions 114 and 115 in the first and third directions.

Similarly, the contents (mol %) of Ti, Mn, and Mg may be measured in the central portion Ca of the capacitance formation portion in the first and third directions by using FE-SEM-EDS (acceleration voltage: 2 kV, magnification: 50,000 times). Accordingly, the amount in mol of Mn and Mg to 100 mol of Ti included in the dielectric layer 111 of the capacitance formation portion Ac may be calculated (A1 and A2). Meanwhile, the amount in mol of Mn and Mg to 100 mol of Ti may be calculated at a plurality of points, for example, five equally spaced points, in the central portion Ca of the capacitance formation portion in the first and third directions, and then the A1 and A2 may be measured by averaging each of the measured values. In this case, the central portion Ca of the capacitance formation portion in the first and third directions may mean, for example, a region having a size of 5 μm×4 μm (third direction×first direction) based on the center of the capacitance formation portion ac in the first and third directions. Additionally, the five equally spaced points may be designated in one or more dielectric layers 111.

ΔMn (S1−A1) and ΔMg (S2−A2) may be measured from the above calculated S1, S2, A1, and A2.

In an embodiment, an average Vickers hardness of the side margin portions 114 and 115 may be greater than or equal to 1100 HV. Accordingly, the multilayer electronic component 100 may be prevented from breaking due to external impact. The Vickers hardness of the side margin portions 114 and 115 may be increase as the density of the side margin portions 114 and 115 improve. The upper limit of the average Vickers hardness of the side margin portions 114 and 115 is not particularly limited, but may be, for example, 1160 HV.

By using a Vickers hardness tester, the hardness may be measured at 5 points equally spaced apart from each other on the first side margin portion 114 in the first direction and at 5 points equally spaced apart from each other on the second side margin portion 115 in the first direction, and then an average of the hardness values at a total of 10 points may be referred to as the average Vickers hardness of the side margin portions 114 and 115. As illustrated in FIG. 6, the Vickers hardness HV may mean (load×9.8)/(d1×d2) (where d1 and d2 are diagonal lengths of indentation marks). Other methods and/or tools appreciated by one of ordinary skill in the art, even if not described in the present disclosure, may also be used.

In an embodiment, in a cross-section of the multilayer electronic component 100 in the first and third directions, the side margin portions 114 and 115 may include at least one 20 μm×10 μm region having 70 or less pores.

The fact that the side margin portions 114 and 115 have at least one 20 μm×10 μm region having 70 or less pores may mean that the side margin portions 114 and 115 have a density of a certain level or higher.

The number of the pores may be measured, for example, by analyzing a cross section of the multilayer electronic component 100 in the first and third directions polished to the ½ point of the multilayer electronic component 100 in the second direction, using an image analysis program. The pores present in the side margin portions 114 and 115 may be easily distinguished through color or contrast. Other methods and/or tools appreciated by one of ordinary skill in the art, even if not described in the present disclosure, may also be used.

The dielectric layer 111 and side margin portions 114 and 115 may optionally include other subcomponents.

In an embodiment, the dielectric layer 111 and the side margin portions 114 and 115 may include one or more of Dy, Tb, Y, Sc, La, Nd, Eu, Gd, Ho, Er, Yb, and Lu (hereinafter referred to as a first subcomponent). The first subcomponent may act to improve the reliability of the multilayer electronic component 100. A total content of the first subcomponent included in the side margin portions 114 and 115 may be, for example, 0.6 mol or more and 3.0 mol or less to 100 mol of Ti.

In an embodiment, the dielectric layer 111 and the side margin portions 114 and 115 may include one or more of Si and Al (hereinafter, referred to as a second subcomponent). The Si may act to improve the density of the side margin portions 114 and 115 by suppressing the grain growth of the dielectric grain included in the side margin portions 114 and 115. The Al may contribute to low-temperature densification through liquefaction during sintering, improve the high-temperature voltage resistance characteristics of the multilayer electronic component 100, and act as an acceptor to reduce electron concentration.

The content of Si included in the side margin portions 114 and 115 may be, for example, 0.75 mol or more and 4.0 mol or less to 100 mol of Ti. The content of Al included in the side margin portions 114 and 115 may be, for example, more than 0 mol and 0.6 mol or less to 100 mol of Ti.

In an embodiment, the dielectric layer 111 and the side margin portions 114 and 115 may include one or more of V, Cr, Fe, Ni, Co, and Zn (hereinafter referred to as a third subcomponent). The third subcomponent corresponds to an atomic variable acceptor element together with Mn. The third subcomponent may act in lowering a sintering temperature and improving the high-temperature voltage resistance characteristics of the multilayer electronic component 100.

In order to appropriately control a microstructure of the side margin portions 114 and 115, the side margin portions 114 and 115 may further include, for example, Dy, Si, Al, and V among the aforementioned subcomponents.

Meanwhile, the cover portions 112 and 113 may include, for example, Mn and Mg at a level similar to the dielectric layer 111 of the capacitance formation portion Ac. In an embodiment, when the amount in mol of Mn to 100 mol of Ti included in the cover portions 112 and 113 is C1, 0.2 mol≤S1−C1≤0.8 mol may be satisfied. In an embodiment, when the amount in mol of Mg to 100 mol of Ti included in the cover portions 112 and 113 is C2, 0 mol≤S2−C2<0.25 mol may be satisfied. C1 and C2 may be measured from an image observed by using, for example, a Scanning Electron Microscope-Energy Dispersive X-ray Spectrometer (SEM-EDS), a Transmission Electron Microscope-Energy Dispersive X-ray Spectrometer (TEM-EDS), a Scanning Transmission Electron Microscope-Energy Dispersive X-ray Spectrometer (STEM-EDS), or a Field Emission-scanning Electron Microscope-Energy Dispersive X-ray Spectrometer (FE-SEM-EDS). Other methods and/or tools appreciated by one of ordinary skill in the art, even if not described in the present disclosure, may also be used.

A size of the multilayer electronic component 100 is not particularly limited. However, there is a significant concern of reduced reliability in multilayer electronic components having a size of 1005 or smaller (length: approximately 1.0 mm, width: approximately 0.5 mm) in which the number of multilayers is increased by reducing a thickness of the dielectric layer and internal electrodes in order to simultaneously achieve miniaturization and high capacitance. Therefore, when the multilayer electronic component 100 according to an embodiment of the present disclosure is applied to an ultra-compact multilayer electronic component having a size of 1005 (length: approximately 1.0 mm, width: approximately 0.5 mm) or smaller, the effect of improving reliability may be more pronounced.

An average thickness td of the dielectric layer 111 and the average thickness the of the internal electrodes 121 and 122 are not particularly limited. However, as the thickness of the dielectric layer and internal electrodes become thinner, the reliability of the multilayer electronic component tends to decrease, and in particular, when the average thickness of the dielectric layer and internal electrodes are 1.0 μm or less, there may be a problem in securing the reliability of the multilayer electronic component. When the multilayer electronic component 100 according to an embodiment of the present disclosure is applied to an ultra-compact multilayer electronic component in which the average thickness td of the dielectric layer 111 is 1.0 μm or less and/or the average thickness the of at least one of the internal electrodes 121 and 122 is 1.0 μm or less, the effect of improving reliability may be more pronounced.

The average thickness td of the dielectric layer 111 and an average thickness the of at least one of the internal electrodes 121 and 122 may mean the average thicknesses of the dielectric layer 111 and at least one of the internal electrodes 121 and 122 in the first direction, respectively. The average thickness td of the dielectric layer 111 and the average thickness the of at least one of the internal electrodes 121 and 122 may be measured by scanning cross sections of the body 110 in the first and third directions with a scanning electron microscope (SEM) at 10,000× magnification. More specifically, the average thickness td of the dielectric layer 111 may be measured by calculating the average after measuring the thickness at a plurality of points of one dielectric layer 111, for example, at 5 points equally spaced apart from each other in the third direction, and then taking the average value. Additionally, the average thickness the of at least one of the internal electrodes 121 and 122 may be measured by calculating the average after measuring the thickness at a plurality of points of one internal electrode 121 and 122, for example, at 5 points equally spaced apart from each other in the third direction. The 5 points equally spaced apart from each other may be designated in the capacitance formation portion Ac. Meanwhile, when the average value measurements are performed for each of 10 dielectric layers 111 and 10 internal electrodes 121 and 122, and then the average values are calculated, the average thickness td of the dielectric layer 111 and the average thickness the of the internal electrodes 121 and 122 may be further generalized. Other methods and/or tools appreciated by one of ordinary skill in the art, even if not described in the present disclosure, may also be used.

An average thickness tc of the cover portions 112 and 113 is not particularly limited. The average thickness tc of the cover portions 112 and 113 may be, for example, 5 μm or more and 100 μm or less. For example, when the multilayer electronic component 100 has 1005 size (length: about 1.0 mm, width: about 0.5 mm) or less, the average thickness tc of the cover portions 112 and 113 may be 5 μm or more and 35 μm or less. The average thickness tc of the cover portions 112 and 113 may refer to an average thickness of each of the first cover portion 112 and the second cover portion 113. The average thickness tc of the cover portions 112 and 113 may refer to an average thickness of the cover portions 112 and 113 in the first direction, and may be an average value of thickness in the first direction measured at 5 points equally spaced apart from each other in a cross-section of the body 110 in the first and third directions.

An average thickness wm of the side margin portions 114 and 115 is not particularly limited. The average thickness wm of the side margin portions 114 and 115 may be, for example, 3 μm or more and 100 μm or less. For example, when the multilayer electronic component 100 has 1005 size (length: about 1.0 mm, width: about 0.5 mm) or less, the average thickness wm of the side margin portions 114 and 115 may be 3 μm or more and 25 μm or less. The average thickness wm of the side margin portions 114 and 115 may refer to an average thickness of each of the first side margin portion 114 and the second side margin portion 115. The average thickness wm of the side margin portions 114 and 115 may refer to an average thickness of the side margin portions 114 and 115 in the third direction, and may be an average value of a thickness in the third direction measured at 5 points equally spaced apart from each other in a cross-section of the body 110 in the first and third directions.

Hereinafter, an example of a method for forming a multilayer electronic component 100 will be described. However, the method of manufacturing the multilayer electronic component 100 is not limited thereto.

First of all, ceramic powder for forming a dielectric layer 111 are prepared. The ceramic powder may include, for example, one or more of BaTiO₃, (Ba₁₋ₓCaₓ) TiO₃ (0<x<1), Ba(Ti_{1-y}Ca_{y})O₃ (0<y<1), (Ba₁₋ₓCaₓ) (Ti_{1-y}Zr_{y})O₃ (0<x<1, 0<y<1), Ba (Ti_{1-y}Zr_{y})O₃ (0<y<1), CaZrO₃, and (Ca₁₋ₓSrₓ) (Zr_{1-y}Ti_{y})O₃ (0<x≤0.5, 0<y≤0.5). BaTio₃ powder may be synthesized, for example, by reacting a titanium raw material such as titanium dioxide with a barium raw material such as barium carbonate. A synthesizing method of the ceramic powder may include methods, for example, a solid phase method, a sol-gel method, a hydrothermal synthesis method, or the like, but the present disclosure may not be limited thereto. Next, the prepared ceramic powder are dried and ground, and then an organic solvent such as ethanol, a binder such as polyvinyl butyral is mixed to prepare a ceramic slurry, and then the ceramic slurry is applied and dried on a carrier film to prepare a sheet for forming a dielectric layer.

Next, conductive paste for an internal electrode containing metal powder, binder, organic solvent, or the like is printed onto the dielectric layer sheet with a predetermined thickness using a screen printing method or a gravure printing method, thereby forming an internal electrode pattern.

Thereafter, the sheet for forming a dielectric layer having the internal electrode pattern printed thereon is peeled off from the carrier film, and then a predetermined number of dielectric layer forming sheets having the internal electrode pattern printed thereon are laminated and pressed to form a ceramic laminate. On the upper and lower portions of the ceramic laminate, a sheet forming a cover portion without an internal electrode pattern, may be laminated in a predetermined amount of layers to form the cover portion 112 and 113 after sintering. Thereafter, the ceramic laminate is cut to have a predetermined size of a chip. At this time, the ends portion of the internal electrode patterns may be exposed on both surfaces of the chip opposing each other in the third direction.

Next, a sheet for forming a margin portion may be attached to both surfaces of the chip opposing in the third direction and then sintered to form the body 110 and the side margin portions 114 and 115. The sintering temperature may be, for example, 1000° C. or higher and 1400° C. or lower, but the present disclosure may not be limited thereto.

The sheet for forming the margin portion may be formed in a similar method to the sheet for forming the dielectric layer, but the content of subcomponents included in the sheet for forming the margin portion may be different from those included in the sheet for forming the dielectric layer.

For example, both the sheet for forming the margin portion and the sheet for forming the dielectric layer may contain ABO₃ perovskite powder as a main component, but the content of Mn included in the sheet for forming the margin portion may be higher than the content of Mn included in the sheet for forming the dielectric layer, and the content of Mg included in the sheet for forming the margin portion may be higher than the content of Mg included in the sheet for forming the dielectric layer.

In addition to Mn and Mg, the sheet for forming the margin portion may add one or more of first subcomponent powder of Dy, Tb, Y, Sc, La, Nd, Eu, Gd, Ho, Er, Yb, and Lu, one or more of second subcomponent powder of Si and Al, and/or one or more of third subcomponent powder of V, Cr, Fe, Ni, Co, and Zn.

The first to third subcomponent powders may be added in the form of oxides and/or carbonates to the sheet for forming the margin portion, but the present disclosure is not limited thereto.

Next, the external electrodes 131 and 132 may be formed. For example, when the base electrode layers 131a and 132a includes a sintered electrode layer, the body 110 may be dipped in an external electrode conductive paste containing metal powder, glass frit, binder, and organic solvent, followed by sintering the conductive paste at a temperature of 500° C. to 900° C. to form a sintered electrode layer.

For example, when the base electrode layers 131a and 132a include a resin electrode layer, the body may be dipped in a conductive resin composition including metal powder, resin, binder, and organic solvent, followed by curing heat treatment at a temperature of 250° C. to 550° C. to form the resin electrode layer.

In addition, an electrolytic plating method and/or an electroless plating method may be additionally performed to form a plated layers 131b and 132b on the base electrode layers 131a and 132a.

### Example

A sample chip of size 0603 (length: approximately 0.6 mm, width: approximately 0.3 mm, thickness: approximately 0.3 mm) was prepared by using the manufacturing method described above. Mn, Mg, Dy, Si, Al and V were added to the sheet for forming the side margin portion of the sample chip. Meanwhile, the contents of Mn and Mg added to the sheet for forming the side margin portion were adjusted for each sample number to vary ΔMn and ΔMg. ΔMn and ΔMg may be measured by analyzing a cross-section in the first and third direction polished to the second direction ½ point of the sample chip using FE-SEM-EDS (acceleration voltage: 2 KV, magnification: 50,000 times). S1 and S2 were measured at the central portions of the side margin portion in the first and third directions, and A1 and A2 were measured at the dielectric layer disposed at the central portions of the capacitance formation portion in the first and third directions.

### 1. Measurement of the Number of Pores

The cross sections in the first and third direction (hereinafter referred to as “analysis cross sections”) polished up to a ½ point of each sample chip for each sample number in the second direction were analyzed by using an image analysis program to analyze the number of pores present in the side margin portion. The number of pores was measured in a 20 μm (T direction dimension)×10 μm (W direction dimension) region in contact with the capacitance formation portion among the side margin portions in the analysis cross-section.

### 2. Measurement of an Average Size of Dielectric Grains

The analysis cross-section of the sample chip for each sample number was analyzed using an image analysis program to measure an average size of the dielectric grains included in the side margin portion. The average size of the dielectric grains included in the side margin was measured in the same region as the region where the number of pores was analyzed.

### 3. Measurement of an Aging Rate

For each sample number, five sample chips were heat-treated at temperature about 150° C. for about one hour, and then the capacitance values were measured after 0 hr, 2 hr, 4 hr, 8 hr, 12 hr, 16 hr, 20 hr, 24 hr, 30 hr, 36 hr, 50 hr, 62 hr, 74 hr, 88 hr, and 100 hr. Afterwards, when an x-axis was plotted as log (hr) and the y-axis was plotted as an average capacitance reduction rate (%) of five chips, a slope of a graph was calculated as an aging rate.

### 4. Moisture Resistance Reliability Evaluation

After mounting four hundred sample chips for each sample number onto a printed circuit board (PCB), a voltage of 6.3 V was applied for eight hours under conditions of 85° C. and 85% RH, if Insulation resistance IR value decreased by more than 2 orders of magnitude from the initial IR value, the sample was determined to be defective, and the number of defective samples were measured.

### 5. MTTF Evaluation

Accelerated life testing HALT was performed on forty sample chips for each sample number under conditions of 105° C. and 15 V until all sample chips failed. Accordingly, the Mean time to failure MTTF was calculated.

### 6. Measurement of a Hardness

The Vickers hardness of the side margin portion was measured using a Vickers hardness tester (load 25 gf and holding time 5 seconds) at the analysis cross-section of the sample chip for each sample number. After measuring a hardness at 5 points equally spaced on the first side margin portion in the first direction and at 5 points equally spaced on the second side margin portion in the first direction, an average value of hardness values at a total of 10 points was obtained. The average value measurement was performed on five sample chips for each sample number, and the average value was calculated as the average Vickers hardness, which listed in Table 1 below.

TABLE 1

| | | | | Size of | | | | |
|---|---|---|---|---|---|---|---|---|
| | | | | crystal | Aging | Moisture | | |
| | ΔMn | ΔMg | Number | grains | rate | resistance | MTTF | Hardness |
| No. | (mol) | (mol) | of pores | (nm) | (%) | reliability | (hr) | (HV) |
| 1 | 0.1 | 0 | 128 | 136 | −2.9 | 2/400 | 11.65 | 1033 |
| 2 | 0.2 | 0 | 70 | 148 | −3.2 | 0/400 | 15.08 | 1145 |
| 3 | 0.5 | 0 | 62 | 156 | −3.2 | 0/400 | 16.78 | 1155 |
| 4 | 0.8 | 0 | 40 | 157 | −3.4 | 0/400 | 18.83 | 1131 |
| 5 | 1.0 | 0 | 40 | 195 | −4.7 | 0/400 | 16.11 | 1145 |
| 6 | 0.5 | 0.1 | 55 | 165 | −3.3 | 0/400 | 15.19 | 1134 |
| 7 | 0.5 | 0.25 | 70 | 234 | −3.3 | 1/400 | 11.65 | 1068 |
| 8 | 0.5 | 0.5 | 112 | 240 | −3.2 | 2/400 | 10.57 | 1012 |

Sample numbers 2 to 4 and 6 satisfy all of 0.2 mol≤ΔMn≤0.8 mol and ΔMg<0.25 mol, thereby confirming that the aging rate, moisture resistance reliability, MTTF, and hardness are all excellent.

However, it may be confirmed that sample number 1 exhibited deterioration in moisture resistance reliability, MTTF, and hardness, which is presumed to be due to insufficient densification of the side margin portion as ΔMn decreased to less than 0.2 mol.

In addition, it may be observed that sample number 5 has excellent moisture resistance reliability, MTTF, and hardness, but the aging rate decreases significantly. This is presumed to result from the excessive diffusion of Mn into the dielectric layer as ΔMn exceeds 0.8 mol, which degraded the capacitance of the sample chip.

Sample numbers 7 and 8 satisfy 0.2 mol≤ΔMn≤0.8 mol, but when ΔMg was greater than or equal to 0.25 mol, a density of the side margin portion deteriorated, resulting in a deterioration in the moisture resistance reliability, MTTF, and hardness of the sample chips.

Accordingly, this shows that when both 0.2 mol≤ΔMn≤0.8 mol and ΔMg<0.25 mol are satisfied, the capacitance characteristics of the multilayer electronic component may be secured while improving a reliability.

The present disclosure is not limit the above-described embodiments and the accompanying drawings but is defined by the appended claims. Therefore, those of ordinary skill in the art may make various replacements, modifications, or changes without departing from the scope of the present disclosure defined by the appended claims, and these replacements, modifications, or changes should be construed as being included in the scope of the present disclosure.

In addition, the expression ‘an example embodiment’ does not mean the same embodiment, and is provided to emphasize and explain different unique characteristics. However, the embodiments presented above do not preclude being implemented in combination with the features of another embodiment. For example, although items described in a specific embodiment are not described in another embodiment, the items may be understood as a description related to another embodiment unless a description opposite for contradictory to the items is in another embodiment.

In the present disclosure, the term “connected” includes not only direct connection but also indirect connection through an adhesive layer or the like. Additionally, the term electrically connected includes both physically connected and not physically connected. The terms “first,” “second,” and the like may be used to distinguish one element from another, and may not limit a sequence and/or an importance, or others, in relation to the elements. In some cases, a first element may be referred to as a second element, and similarly, a second element may be referred to as a first element without departing from the scope of right of the example embodiments.

As one of the various effects of the present disclosure, a multilayer electronic component with excellent reliability can be provided.

While example embodiments have been shown and described above, it will be apparent to those skilled in the art that modifications and variations could be made without departing from the scope of the present invention as defined by the appended claims.

What is claimed is:

1. A multilayer electronic component comprising:
a body including a capacitance formation portion including a dielectric layer and internal electrodes alternately disposed with the dielectric layer in a first direction, first and second surfaces opposing each other in the first direction, third and fourth surfaces connected to the first and second surfaces and opposing each other in a second direction, and fifth and sixth surfaces connected to the first to fourth surfaces and opposing each other in a third direction;
an external electrode disposed on the third and fourth surfaces; and
a side margin portion disposed on the fifth and sixth surfaces,
0.2 mol≤S1−A1≤0.8 mol and S2−A2<0.25 mol are satisfied, where an amount in mol of Mn and Mg for 100 moles of Ti included in the side margin portion are S1 and S2, respectively, and an amount in mol of Mn and Mg for 100 moles of Ti included in the dielectric layer of the capacitance formation portion are A1 and A2, respectively.

2. The multilayer electronic component of claim 1, wherein S1 satisfies 0.1 mol≤S1≤1.1 mol.

3. The multilayer electronic component of claim 1, wherein S2 satisfies 0.45 mol≤S2≤1.25 mol.

4. The multilayer electronic component of claim 1, wherein S1 and S2 are measured from a central portion of the side margin portion in the first and third direction,
wherein A1 and A2 are measured from a central portion of the capacitance formation portion in the first and third direction.

5. The multilayer electronic component of claim 1, wherein the side margin portion further includes one or more selected from Dy, Tb, Y, Sc, La, Nd, Eu, Gd, Ho, Er, Yb, and Lu.

6. The multilayer electronic component of claim 1, wherein the side margin portion further includes one or more selected from Si and Al.

7. The multilayer electronic component of claim 1, wherein the side margin portion further includes one or more selected from V, Cr, Fe, Ni, Co, and Zn.

8. The multilayer electronic component of claim 1, wherein the side margin portion further includes Dy, Si, Al and V.

9. The multilayer electronic component of claim 1, wherein an average Vickers hardness of the side margin portion is 1100 HV or higher.

10. The multilayer electronic component of claim 1, wherein in a cross section of the multilayer electronic component in the first and third direction, the side margin portion includes at least one 20 μm×10 μm region having 70 or less pores.

11. The multilayer electronic component of claim 1, wherein the body includes a cover portion disposed on both surfaces of the capacitance formation portion opposing in the first direction,
wherein 0.2 mol≤S1−C1≤0.8 mol is satisfied, where the amount in mol of Mn per 100 moles of Ti included in the cover portion is C1.

12. The multilayer electronic component of claim 1, wherein the body further includes a cover portion disposed on both surfaces of the capacitance formation portion opposing in the first direction,
wherein S2−C2<0.25 is satisfied, where an amount in mol of Mg per 100 moles of Ti included in the cover portion is C2.

13. The multilayer electronic component of claim 1, wherein an average thickness of the dielectric layer is 1.0 μm or less.

14. The multilayer electronic component of claim 1, wherein an average thickness of at least one of the internal electrodes is 1.0 μm or less.

15. A method of manufacturing the multilayer electronic component of claim 1, comprising:
attaching a sheet for forming the side margin portion to opposing surfaces of a chip,
wherein the sheet comprises Mn and Mg, the chip comprises a ceramic laminate that comprises a dielectric sheet, and the dielectric sheet includes:
Mn in an amount that is lower than an amount of Mn in the sheet for forming the side margin portion, and
Mg in an amount that is lower than an amount of Mg in the sheet for forming the side margin portion.

16. The method of claim 15, wherein the sheet for forming the side margin portion further comprises Dy, Si, Al and V.

17. The method of claim 15, further comprising sintering the chip and the sheet for forming the side margin portion to form the body and the side margin portion.
